(19) United States
(12) Patent Application Publication
(10) Pub. No.: US 2011/0266728 A1
(43) Pub. Date: Nov. 3, 2011

(54) AIR SPRING

(76) Inventor: Christoph Bank, Lehrte (DE)

(21) Appl. No.: 13/157,497

(22) Filed: Jun. 10, 2011

Related U.S. Application Data
(63) Continuation of application No. PCT/EP2009/064356, filed on Oct. 30, 2009.

(30) Foreign Application Priority Data
Dec. 11, 2008 (DE) 10 2008 055 509.6

(51) Int. Cl. F16F 9/05; F16F 9/04

(52) U.S. Cl. 267/64.27

(57) ABSTRACT

An air spring (1) for commercial vehicles has a first connecting part (2), in particular in the form of a cover, a second connecting part (3) in the form of a roll-off piston, a rolling lobe flexible member (4) made from elastomeric material, wherein a first end (4a) thereof can be fastened seal tight to the first part (2) by a first fastening device (5a) and a second end (4b) of the flexible member (4) can be fastened seal tight to the roll-off piston (3) by a second fastening device (5b). The roll-off piston (3) is made of plastic and the second fastening device (5b) is not made from metal, and/or the first part (2) is made of plastic and the first fastening device (5a) is not made from metal.

### CROSS REFERENCE TO RELATED APPLICATIONS

This application is a continuation application of international patent application PCT/EP 2009/064356, filed Oct. 30, 2009, designating the United States and claiming priority from German application 10 2008 055 509.6, filed Dec. 11, 2008, and the entire content of both applications is incorporated herein by reference.

### FIELD OF THE INVENTION

The invention relates to an air spring for commercial vehicles, comprising a first connection part, in particular in the form of a cover, a second connection part in the form of a roll-off piston and a rolling lobe flexible member made of elastomeric material, wherein a first end of the rolling lobe flexible member can be fastened seal tight to the first connection part by means of a first fastening means and a second end of the rolling lobe flexible member can be fastened seal tight to the roll-off piston by means of a second fastening means.

### BACKGROUND OF THE INVENTION

Such air springs are known per se and are used in a wide range of commercial vehicles, for example in traction vehicles and trailers.

The rolling lobe flexible member itself consists of an elastomeric material, preferably of rubber or a rubber-like plastic, and often has fastening beads at the ends.

The rolling lobe flexible member can be fastened or clamped to the connection parts in a positively locking manner using clamping rings or by simply sliding the fastening beads of the rolling lobe flexible member onto conical sealing surfaces. The fastening beads of the rolling lobe flexible member are usually reinforced with embedded bead cores or annular bodies or Pierce cores that have a high tensile strength and are made of steel or steel wire, and bear seal tight against associated conical seat surfaces of the connection parts under the action of the internal pressure of the rolling lobe flexible member.

The connection between the rolling lobe flexible member and the connection parts can also be produced using screw-on clamping plates, which fix the rolling lobe flexible member to the corresponding connection part, in particular on the roll-off piston. In the case of this fastening, the internal volume of the roll-off piston is used for the screw-on connection, and therefore the internal volume is then no longer available for minimizing the natural frequency. An air spring having such a connection between the rolling lobe flexible member and the roll-off piston is not intended to be the subject matter of the present invention.

The connection parts can additionally be connected to the rolling lobe flexible member by means of a flanged plate, where such a flanged plate usually reaches around a corresponding fastening bead of the rolling lobe flexible member and is thus connected non-releasably to the rolling lobe flexible member fixedly and in an airtight manner. It is thereby advantageously possible to transfer high tension forces.

Furthermore, it is known to form the connection parts, that is, the roll-off piston and/or the cover or the cover plate, from plastic. As a result, the connection parts are protected against corrosion and advantageously have a much lower weight compared to conventional connection parts made of metal. This has the disadvantage that it has been found that such air springs are often not tight in the event of temperature fluctuations.

### SUMMARY OF THE INVENTION

On the basis of this prior art, it is an object of the invention to provide an air spring of the kind described above wherein one connection part or the other connection part consists of plastic and wherein a tight connection is ensured between the rolling lobe flexible member and the connection part even in the event of temperature fluctuations.

The air spring of the invention is for a vehicle and includes: a first part; a second part in the form of a roll-off piston; a rolling lobe flexible member having first and second ends and being made of an elastomeric material; a first fastening element configured to fix the first end of the rolling lobe flexible member seal tight to the first part thereby providing a first connection; a second fastening element configured to fix the second end of the rolling lobe flexible member seal tight to the second part thereby providing a second connection; and, in at least one of the first and second connections, the part thereof being made of plastic and the fastening element thereof being made of non-metallic material.

According to an embodiment of the invention, the roll-off piston consists of plastic and the second fastening means is not made of metal and/or that the first connection part consists of plastic and the first fastening means is not formed from metal.

It has been found that it is thereby possible to obtain an airtight and fixed connection between the rolling lobe flexible member and the connection part at any expected operating temperature of the air spring. Such a connection can be produced efficiently and at low cost.

In the case of an air spring having a roll-off piston made of plastic, to which the rolling lobe flexible member is connected via a conical sealing surface by means of at least one fastening means made of metal, usually by means of a rubber-metal connection, it has been found that the tightness of this so-called conical seat construction is not ensured.

The invention is based on the understanding that the lack of tightness can be attributed to the fact that the coefficients of linear expansion of plastic and steel differ by a factor of 10.

An embodiment of the invention provides for that end of the rolling lobe flexible member which faces toward the roll-off piston to be provided with a fastening bead having a bead core, wherein the bead core consists of plastic.

The development is likewise based on the understanding that, in the case of a rolling lobe flexible member with a fastening bead at the end and metallic bead cores for connection to the roll-off piston, although the internal pressure in the air spring usually presses the fastening bead into the conical sealing surface or into the conical seat of the roll-off piston, in the event of temperature changes the differing coefficients of linear expansion of plastic and metal mean that the diameters of the conical seat on the piston side consisting of plastic and of the bead core consisting of metal on the rolling lobe flexible member side change so greatly that the conical seat no longer has a sealing effect given a low internal pressure in the air spring.

Since the bead core or Pierce core made of metal or steel is replaced by a bead core made of plastic, preferably of polyamide, a preferred material pairing of an elastomer, specifically of the rolling lobe flexible member, and a plastic, specifically of the roll-off piston and of the bead core, is obtained at the conical seat, and therefore the roll-off piston and the fastening bead of the rolling lobe flexible member expand to the same extent under the influence of temperature. The tightness is thereby provided over the entire temperature range expected for the operation of the air spring.

The roll-off piston and the bead core expediently consist of a plastic having the same or a similar coefficient of linear expansion. The tightness of the air spring is thereby ensured to a particular extent. The materials for the connection parts and for the fastening means, in particular for the bead cores, can be matched optimally to one another.

An advantageous embodiment of the invention provides for that end of the rolling lobe flexible member which faces toward the first connection part to be provided with a fastening bead having a bead core, wherein the bead core consists of plastic.

The first connection part and the bead core preferably consist of a plastic having the same or a similar coefficient of linear expansion. The materials for the connection parts and for the fastening means, in particular for the bead cores, can be matched optimally to one another.

Practically, it is provided that a conical sealing surface or a conical seat is provided in each case on the connection part for the connection between the rolling lobe flexible member and the second connection part and/or for the connection between the rolling lobe flexible member and the first connection part.

One embodiment of the invention provides for the bead core to be produced by injection molding.

An advantageous refinement of the invention provides for the bead core to have recesses or bores which can be filled with the elastomer of the rolling lobe flexible member during vulcanization.

One embodiment of the invention provides that the cross-sectional shape of the fastening means or of the bead core can be selected in such a way that it can be adapted to the type of connection known to a person skilled in the art between the rolling lobe flexible member and the first and/or second connection part.

The fastening means and/or the bead core preferably has a round, rectangular, oval, wedge-like, semi-oval or semicircular cross section.

An advantageous refinement of the invention provides for the fastening means and/or the bead core to be provided on its outer surface with an additional profile in the form of holding projections or holding tabs.

### BRIEF DESCRIPTION OF THE DRAWINGS

The invention will now be described with reference to the drawings wherein:

FIGS. 1a to 1c show a first exemplary embodiment; and,

FIGS. 2a to 2c show a second exemplary embodiment.

### Specifically:

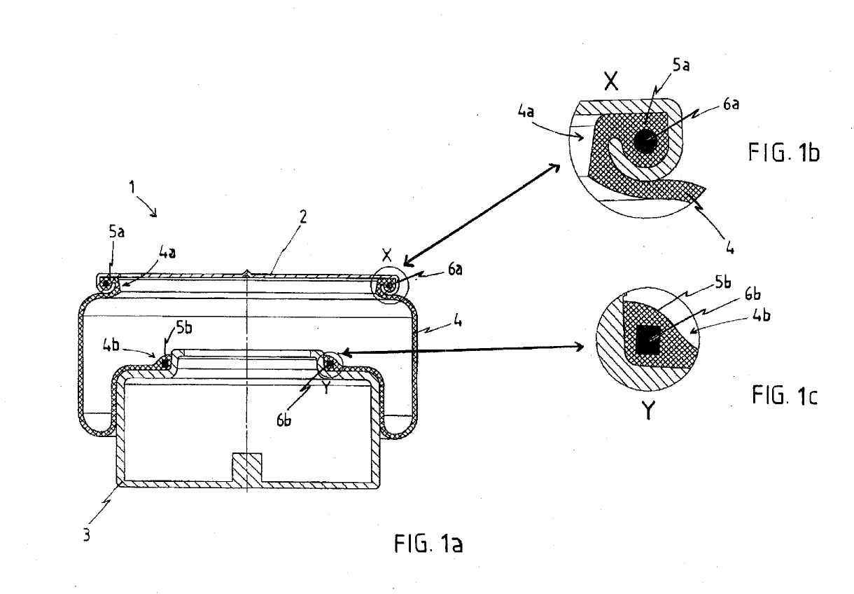

FIG. 1a shows an air spring in longitudinal section; and,

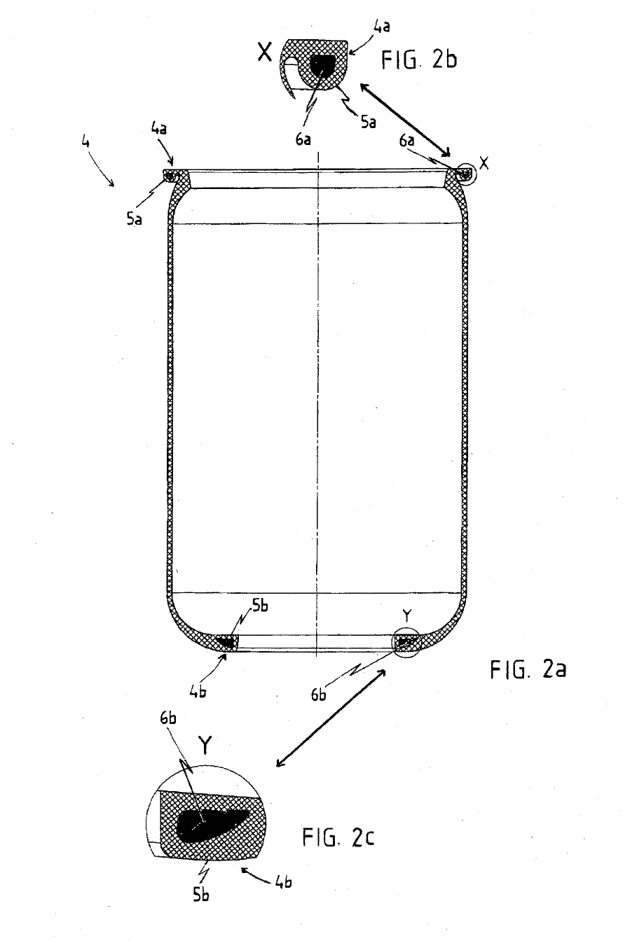

FIG. 2a shows a rolling lobe flexible member in longitudinal section,

FIGS. 1b and 2b each show the detailed view X; and,

FIGS. 1c and 2c each show the detailed view Y.

### DESCRIPTION OF THE PREFERRED EMBODIMENTS OF THE INVENTION

Identical parts are always provided with the same reference symbols in FIGS. 1a to 2c of the drawing.

FIGS. 1a to 1c show an air spring 1 for commercial vehicles comprising a cover 2, a roll-off piston 3 and a rolling lobe flexible member 4 made of elastomeric material. The roll-off piston 3 consists of plastic.

That end 4b of the rolling lobe flexible member 4, which faces toward the roll-off piston 3, is provided with a fastening bead 5b having a bead core 6b. According to the invention, the bead core 6b consists of plastic.

That end 4a of the rolling lobe flexible member 4, which faces toward the cover 2, is provided with a further fastening bead 5a having a bead core 6a. The bead core 6a also consists of plastic in accordance with the invention.

The connection of the rolling lobe flexible member 4 to the cover 2 and to the roll-off piston 3 is known to a person skilled in the art. The cover 2 has a flanged portion, which reaches around the fastening bead 5a in an airtight manner. By contrast, the roll-off piston has a conical seat, against which the fastening bead 5b bears in an airtight manner.

The bead core (6a, 6b) is produced by injection molding. The cross-sectional shape of the bead core (6a, 6b) is selected in such a way that it can be adapted optimally to the type of connection, and therefore to the airtightness, of the rolling lobe flexible member 4 to the cover 2 and to the roll-off piston 3.

FIGS. 2a to 2c show a rolling lobe flexible member 4 having fastening beads 5a and 5b at the ends. The bead cores (6a, 6b) of the fastening beads consist of plastic and have an optimized cross section.

Thus, it can be readily seen in FIG. 2b that optimization is achieved owing to the selected, slightly oval cross-sectional shape of the bead core 6a, since the corresponding flanged portion of the cover 2 likewise has a more oval than round form in section. The cross-sectional shape of the bead core 6b in FIG. 2c is also adapted. It can clearly be seen that the loop of the fastening bead 5b can be placed much better around the bead core 6b than would be the case given a square cross section, for example. It is thereby advantageously possible to dispense with profile strips which are otherwise required.

It is understood that the foregoing description is that of the preferred embodiments of the invention and that various changes and modifications may be made thereto without departing from the spirit and scope of the invention as defined in the appended claims.

### LIST OF REFERENCE SYMBOLS

### (Forms Part of the Description)

1 Air spring
2 First connection part (cover)
3 Second connection part (roll-off piston)
4 Rolling lobe flexible member
4a First end of the rolling lobe flexible member
4b Second end of the rolling lobe flexible member
5a First fastening means (fastening bead)
5b Second fastening means (fastening bead)
6a Bead core
6b Bead core

What is claimed is:

1. An air spring for a vehicle comprising:
a first part;
a second part in the form of a roll-off piston;
a rolling lobe flexible member having first and second ends and being made of an elastomeric material;
a first fastening element configured to fix said first end of said rolling lobe flexible member seal tight to said first part thereby providing a first connection;
a second fastening element configured to fix said second end of said rolling lobe flexible member seal tight to said second part thereby providing a second connection; and,
in at least one of said first and second connections, the part thereof being made of plastic and the fastening element thereof being made of non-metallic material.

2. The air spring of claim 1, wherein said first part is a cover.

3. The air spring of claim 1, wherein said second end of said rolling lobe flexible member has a fastening bead having a bead core made of plastic.

4. The air spring of claim 3, wherein said roll-off piston and said bead core of said fastening bead of said second end are made of respective plastics having the same or similar coefficient of linear expansion.

5. The air spring of claim 1, wherein said first end of said rolling lobe flexible member has a fastening bead having a bead core made of plastic.

6. The air spring of claim 5, wherein said first part and said bead core are made of respective plastics having the same or similar coefficients of linear expansion.

7. The air spring of claim 1, further comprising a conical seat disposed on at least one of said first and second parts for the connection between said one part and said rolling lobe flexible member.

8. The air spring of claim 3, wherein said bead core is produced by injection molding.

9. The air spring of claim 3, wherein said bead core has at least one of recesses and bores configured to be fillable with said elastomeric material of said rolling lobe flexible member during vulcanization.

10. The air spring of claim 1, wherein at least one of said first and said second fastening elements have a cross section configured to be selectable in such a manner that said cross section is adaptable to the connection between said rolling lobe flexible member and the corresponding one of at least one of said first and said second parts.

11. The air spring of claim 3, wherein said bead core has a cross section configured to selectable in such a manner that said cross-section is adaptable to the connection between said rolling lobe flexible member and the corresponding one of at least one of said first part and said second part.

12. The air spring of claim 10, wherein said first and said second fastening elements have one of a round, a rectangular, an oval, a wedge-like, a semi-oval and a semicircular cross section.

13. The air spring of claim 11, wherein said bead core has one of a round, a rectangular, an oval, a wedge-like, a semi-oval, and a semicircular cross section.

14. The air spring of claim 12, wherein said first and said second fastening elements have an additional profiled section having holding projections or holding tabs.

15. The air spring of claim 13, wherein said bead core has an additional profiled section or holding tabs.

16. An air spring for a vehicle comprising:
a first part in the form of a cover made of plastic;
a second part in the form of a roll-off piston made of plastic;
a rolling lobe flexible member having first and second ends and being made of an elastomeric material;
a first fastening element configured to fix said first end of said rolling lobe flexible member seal tight to said first part thereby providing a first connection;
a second fastening element configured to fix said second end of said rolling lobe flexible member seal tight to said second part thereby providing a second connection; and,
said first and second fastening elements being made of non-metal material.

17. The air spring of claim 16, wherein said second end of said rolling lobe flexible member has a fastening bead having a bead core made of plastic.

18. The air spring of claim 17, wherein said roll-off piston and said bead core of said fastening bead of said second end are made of respective plastics having the same or similar coefficient of linear expansion.

19. The air spring of claim 16, wherein said first end of said rolling lobe flexible member has a fastening bead having a bead core made of plastic.

20. The air spring of claim 19, wherein said cover and said bead core are made of respective plastics having the same or similar coefficients of linear expansion.
